(19) United States
(12) Patent Application Publication
(10) Pub. No.: US 2010/0183176 A1
(43) Pub. Date: Jul. 22, 2010

(54) HEARING SYSTEM WITH ASSISTANCE FUNCTIONALITY

(75) Inventor: Stefan Schwarz, Hombrechtikon (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/665,443

(22) PCT Filed: Jun. 22, 2007
(86) PCT No.: PCT/EP07/56233

§ 371 Date: Dec. 18, 2009

(51) Int. Cl. H04R 25/00

(52) U.S. Cl. 381/312

(57) ABSTRACT

The hearing system (1) has an assistance functionality, which is capable of providing an individual (2) using said hearing system (1) with assistance information. Such assistance information comprises at least one of explanatory information; instructional information; guiding information. Preferably, said assistance functionality can be customized for an individual (2) using said hearing system (1). The method of operating a hearing system comprises the step of assisting an individual (2) using said hearing system (1) by means of an assistance functionality of said hearing system. The method of manufacturing a hearing system (1) comprises the step of providing said hearing system with an assistance functionality of the above-described kind. An enhanced usability of the hearing system can be achieved.

### TECHNICAL FIELD

The invention relates to the field of hearing systems. It relates to methods and apparatuses according to the opening clause of the claims.

A hearing system comprises at least one hearing device. Typically, a hearing system comprises, in addition, at least one additional device, which is operationally connected to said hearing device, e.g., another hearing device, a remote control or a remote microphone. The devices of a hearing system are usually meant to be worn or carried by an individual using the hearing system.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may typically be applied behind the ear, in the ear, completely in the ear canal or may be implanted.

An individual using a hearing system is also referred to as a user of said hearing system.

### BACKGROUND OF THE INVENTION

Today, programmable digital hearing devices are widely available. Such hearing devices provide a large number of features, which can make it difficult for an individual using the hearing device to use and remember these features. Usually, the features are explained in a User's Guide or a Handbook. However, it is cumbersome to carry such a booklet whenever using the hearing device.

### SUMMARY OF THE INVENTION

Therefore, one object of the invention is to create a hearing system that does not have the disadvantages mentioned above. A hearing system shall be provided, which has an improved usability. In addition, the respective method of operating a hearing system, a method of manufacturing a hearing system and a computer program product shall be provided.

Another object of the invention is to provide for an improved way for providing support for an individual using said hearing system.

Further objects emerge from the description and embodiments below.

At least one of these objects is at least partially achieved by apparatuses and methods according to the patent claims.

According to the invention, the hearing system has an assistance functionality.

Through this, an enhanced ease of use of the hearing system can be achieved. The hearing system can provide an individual using said hearing system with valuable support. In addition, such an assistance functionality has a great degree of availability, since it is an integrated part of the hearing system, i.e, it is comprised in the hearing system.

In one embodiment, said assistance functionality is capable of providing an individual using said hearing system with assistance information. Through this, the hearing system is capable of providing support for said individual by providing helpful information.

This assistance information can be or comprise visual information, i.e., information to be visually presented to said individual.

This assistance information can be or comprise audible information, i.e., information to be audibly presented to said individual.

In one embodiment, at least a part of said assistance information is presentable to said individual by means of at least one of a remote control of said hearing system and a hearing device of said hearing system. A remote control of said hearing system comprising a display is particularly well suited for presenting visual assistance information; a hearing device of said hearing system is particularly well suited for presenting audible assistance information.

In one embodiment, said assistance information comprises at least one of
explanatory information;
instructional information;
guiding information;
information concerning sources of assistance external to the hearing system.

E.g., it is possible to comprise in said assistance information that is usually comprised in a User's Guide or in a Handbook. Said assistance information can comprise information describing or explaining the hearing system as a whole and/or information describing or explaining one or more devices of said hearing system. In particular, said assistance information can comprise information describing or explaining features and/or functionalities of said hearing system. E.g., said assistance information can describe steps required for accessing certain features or functionalities of the hearing system.

Said assistance information may also comprise status information, which informs said individual about a current status of the hearing system, e.g., the current volume setting or the number of the currently selected hearing program. But such assistance information alone is not considered assistance information in form of explanatory information or instructional information or guiding information.

Said information concerning sources of assistance external to the hearing system can be or comprise information describing how to reach and/or in which cases to reach at least one source of assistance external to the hearing system. Said information concerning sources of assistance external to the hearing system can be or comprise, e.g., contact information of a source of assistance external to the hearing system, e.g., a name, a telephone number, an address, an internet address of, e.g., hearing device fitter or a hearing device manufacturer.

In one embodiment, said hearing system comprises at least one device having at least one display, wherein said assistance functionality is capable of making use of said display. Such a display can be, e.g., a Liquid Crystal Display (LCD), e.g., comprised in a remote control of said hearing system. A display can be used for displaying at least a portion of said assistance information.

In one embodiment, said assistance functionality can be customized for an individual using said hearing system. This means, that some degree of individualization of said assistance functionality is possible. I.e., said assistance functionality is adaptable to individual needs and preferences of said individual. This way, it is possible to provide different hearing system users, even users, which use the same make and model of hearing system, with a different (individual) assistance functionality.

In one embodiment, said assistance information comprises a selection of pre-defined portions of assistance information, which selection is customized for said individual. In this case, there exists, e.g., in a data bank at the hearing system manufacturer, a pool of chunks of assistance information, from which a selection can be made, individually for said individual. This can help to save memory space in the hearing system.

In one embodiment, said assistance information comprises a set of pre-defined portions of assistance information, wherein the accessibility of said pre-defined portions of assistance information is customized for said individual. In this case said assistance information can, e.g., be accessed using an individualized menu structure. This allows to create an individually improved access to assistance information for each user. It is, e.g., possible to allow access only to such portions of assistance information, which are of particular importance to said individual, and/or to ease the access to particular portions of assistance information by positioning them in upper positions in menus.

In one embodiment, said assistance information comprises a set of portions of assistance information, wherein at least one of said portions of assistance information comprises assistance information entered specifically for said individual. In this embodiment, assistance information can be generated specifically for said individual. E.g., if said individual is forgetful, it is possible to comprise the address and/or telephone number of the responsible hearing device professional in said assistance information. And/or, it is possible to provide in a list of available hearing programs a name and/or a description of said hearing programs which is/are specifically chosen for said individual (typically during a fitting session). Said description of said hearing programs may, e.g., be or comprise information describing situations in which the respective hearing program can or should be used.

According to the invention, the method of operating a hearing system comprises the step of
a) assisting an individual using said hearing system by means of an assistance functionality of said hearing system.

In one embodiment, step a) comprises the step of
b) providing said individual with assistance information.

In one embodiment, said assistance information comprises at least one of
explanatory information;
instructional information;
guiding information.

In one embodiment, a display of said hearing system is used for carrying out step b).

In one embodiment, said method comprises at least one of the steps of
c) customizing said assistance functionality for said individual;
d) using a customized assistance functionality for carrying out step a).

Step c) can be carried out, e.g., by said individual and/or by the responsible hearing device professional such as an audiologist and/or a hearing system dispenser. Said customized assistance functionality is usually customized for said individual.

According to the invention, the method of manufacturing a hearing system comprises the step of
m) providing said hearing system with an assistance functionality.

In one embodiment, said assistance functionality is capable of using a display of a device of said hearing system for providing an individual using said hearing system with assistance information.

In one embodiment, said assistance functionality is customized for an individual using said hearing system. This method can also be considered a method of manufacturing a hearing system individualized for an individual using said hearing system.

In one embodiment, said method comprises the step of
n) creating an assistance functionality customized for said individual.

Said creating of an assistance functionality can be or comprise adjusting an existing assistance functionality.

In one embodiment, a hearing system fitting software is used for carrying out step m).

In one embodiment, step n) is carried out by a dispenser of said hearing system.

In one embodiment, step n) is carried out by said individual.

In one embodiment, step n) comprises entering text specifically for said user.

According to the invention, the computer program product comprises program code for causing a computer to perform the steps of
p) assisting a person using said computer program product in fitting a hearing system to hearing preferences of an individual using said hearing system;
q) loading definition data into a device of said hearing system, which define an assistance functionality.

Step p) is what is typically done by means of software usually referred to as “fitting software”, i.e., hearing parameters are adjusted for achieving a suitable hearing sensation for the user.

Considered under a slightly different point of view, one can say that a fitting software is used for implementing an assistance function in the hearing system, in particular wherein said assistance functionality is customized for an individual using said hearing system.

In one embodiment, said program code is adapted to causing said computer to perform the step of
r) assisting a person using said computer program product in customizing said definition data for said individual.

In one embodiment, said definition data comprises data representing assistance information to be displayed to said individual.

The advantages of the methods and computer program products correspond to the advantages of corresponding apparatuses.

It is pointed out, that the above-described embodiments can be combined with one or more of the other above-mentioned embodiments.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a schematic illustration sketching the invention;

FIG. 2 a schematic illustration sketching a help menu displayed in a display of a hearing system;

FIG. 3 a schematic illustration sketching a help menu displayed in a display of a fitting computer.

The reference symbols used in the figures and their meaning are summarized in the list of reference symbols. The described embodiments are meant as examples and shall not confine the invention.

### DETAILED DESCRIPTION OF THE INVENTION

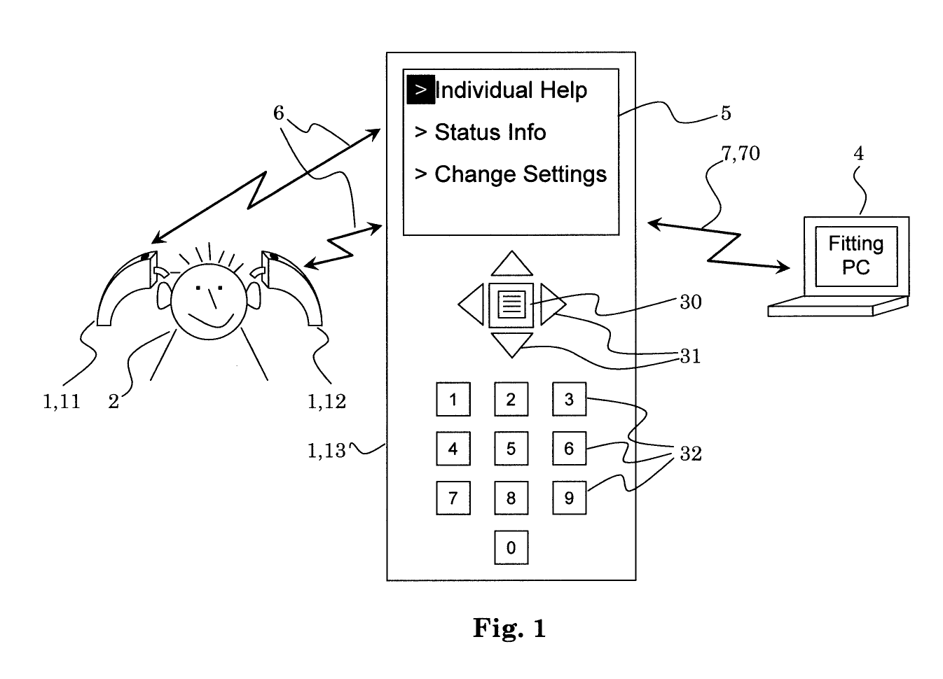

FIG. 1 shows a schematic illustration sketching the invention. An individual 2 is user of a hearing system 1. Hearing system 1 comprises two hearing devices 11,12 and a remote control 13. The devices 11,12,13 of the hearing system 1 are operationally interconnected by communication connections 6, which are preferably wireless connections. Possibly, a direct communication link between the two hearing devices 11,12 is provided, which is not shown in FIG. 1.

The remote control 13 is a dedicated remote control of the hearing system 1 and comprises a display 5, which allows to display assistance information to user 2. As shown in FIG. 1, the remote control can allow to select between several different functionalities such as an assistance functionality which provides individual help to user 2, a status control functionality, which allows user 2 to monitor important status information concerning the hearing system 1 such as the status of batteries of the hearing system, and a parameter setting functionality, which allows the user to adjust important parameters of the hearing system, such as output volume or the name or number of a hearing program to be used.

Said assistance functionality is capable of displaying assistance information in display 5.

Remote control 13 has a user interface comprising several user controls, such as buttons 30,31,32. E.g., button 30 can be used for selecting an item, buttons 31 can be used for moving a cursor, and buttons 32 can be used for entering numbers.

It is to be noted that a remote control does not necessarily have to be a dedicated remote control. It can also be device having a different principal functionality, which nevertheless realizes the functionality of a remote control of the hearing system, e.g., a mobile phone, which is used as a remote control of a hearing system.

For fitting the hearing system 1 to the hearing needs of user 2, hearing system 1 can be operationally connected to a computer system 4. Said computer system 4 is usually located at and operated by a hearing device professional. A wireless or wirebound connection 7 between hearing system 1 and computer system 4 is therefor established. Furthermore, it is possible to adjust said assistance functionality for said user 2 by means of the same software as used for the audio fitting; and it is also or alternatively possible to use a different software and/or a different computer system for this. It is possible to transfer definition data 70 into hearing system 1, e.g., into remote control 13. Such definition data 70 define—at least in part—an assistance functionality. Such definition data 70 typically comprise data representing assistance information to be displayed to said individual.

It is also possible to provide that said assistance function is adjustable by said user 2. This can be accomplished without using means external to the hearing system or using external means such as a computer system, e.g., said computer system 4.

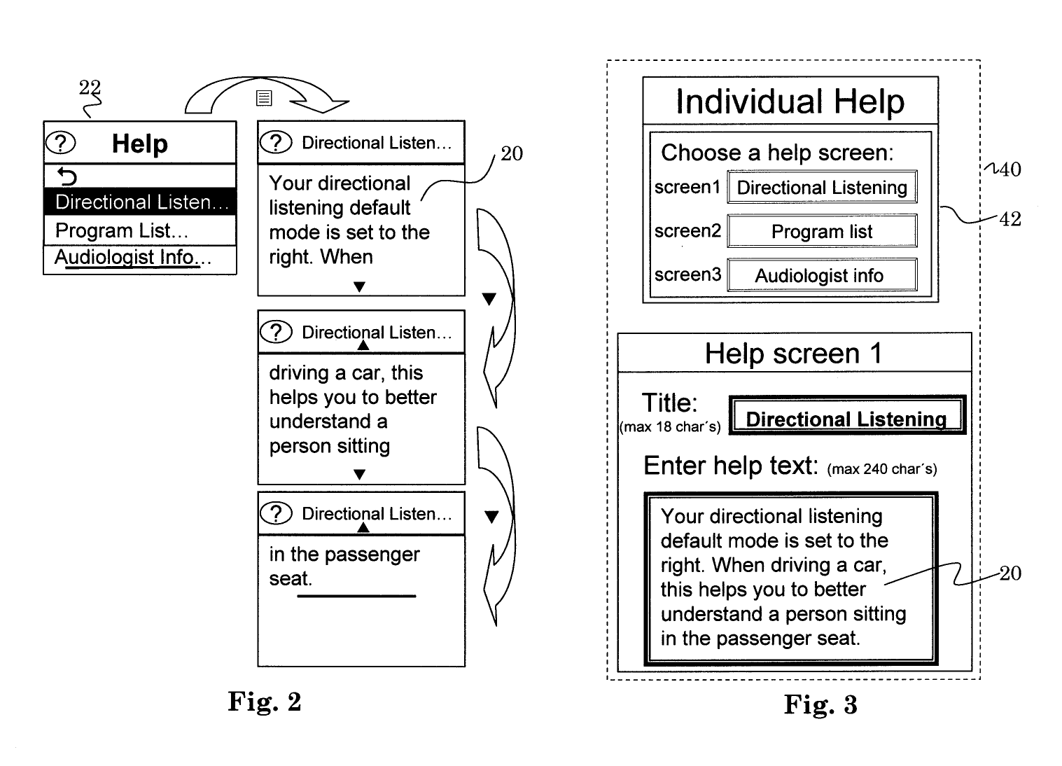

FIG. 2 shows a schematic illustration sketching a help menu 22 displayed in a display 5 of a hearing system 1 (cf. FIG. 1, too). Help menu 22 can be invoked, e.g., by selecting the first menu point shown in FIG. 1 by pressing button 30.

In help menu 22, several topics are selectable, such as information related to directional listening, a listing of available hearing programs with individualized descriptions thereof and information about the audiologist.

The assistance functionality allows to provide user 2 with information which otherwise would only be available in a handbook which one usually does not have available when a problem occurs, or with information the audiologist usually provides only verbally and which tends to be forgotten by the time it is needed, or with other information related to the hearing system 1. E.g., under “audiologist info”, the name, address and telephone number of the audiologist could be recalled.

E.g., by pressing button 30 (FIG. 1) when help menu 22 has a status as shown in FIG. 2, assistance information 20 concerning directional listening can be called. This is shown in the right part of FIG. 2. Using the cursor-down button 31 allows to line- or pagewise display guiding information concerning directional listening in form of several lines of text presented in a display of hearing system 1.

FIG. 3 shows a schematic illustration sketching a help menu 42 displayed in a display 40 of a fitting computer 4 (cf. FIG. 1). This shall illustrate how a customized assistance functionality can be created.

In said help menu 42 displayed in a display of computer system 4 (cf. FIG. 1), several help screens can be selected and/or defined.

Choosing one of these help screens, e.g., the first one, allows to name the help screen, e.g., in the way as shown in FIGS. 2 and 3, and a text, e.g., as shown in FIGS. 2 and 3, can be entered. Such a text is considered assistance information 20. It is also possible to choose from pre-defined texts or figures and enter those as assistance information 20, either in their original form, or in amended form.

When the data for the assistance functionality are composed in a desired way, usually considering the needs of user 5, corresponding definition data 70 are generated and transmitted to the hearing system 1, e.g., to remote control 13.

The invention provides for a highly available, and in particular a customized means for helping a user of a hearing system in dealing with and/or understanding his hearing system.

### LIST OF REFERENCE SYMBOLS

1 hearing system
2 individual, hearing system user
4 computer system, computer
5 display
6 communication connection
7 communication connection
11 hearing device
12 hearing device
13 remote control
20 assistance information
22 help menu
30 button, selecting button
31 button, cursor button
32 button, numerical button
40 display of fitting software
42 help menu
70 definition data

What is claimed is:

1. A hearing system having an assistance functionality.

2. The hearing system according to claim 1, wherein said assistance functionality is capable of providing an individual using said hearing system with assistance information.

3. The hearing system according to claim 1 or claim 2, wherein said assistance information comprises at least one of
explanatory information;
instructional information;
guiding information;
information concerning at least one source of assistance external to said hearing system.

4. The hearing system according to claim 1, comprising at least one device having at least one display, wherein said assistance functionality is capable of making use of said display.

5. The hearing system according to claim 1, wherein said assistance functionality can be customized for an individual using said hearing system.

6. The hearing system according to claim 2, wherein said assistance information comprises a selection of pre-defined portions of assistance information, which selection is customized for said individual.

7. The hearing system according to claim 2, wherein said assistance information comprises a set of pre-defined portions of assistance information, and wherein the accessibility of said pre-defined portions of assistance information is customized for said individual.

8. The hearing system according to claim 2, wherein said assistance information comprises a set of portions of assistance information, and at least one of said portions of assistance information comprises assistance information entered specifically for said individual.

9. A method of operating a hearing system, comprising the step of
a) assisting an individual using said hearing system by means of an assistance functionality of said hearing system.

10. The method according to claim 9, wherein step a) comprises the step of
b) providing said individual with assistance information.

11. The method according to claim 10, wherein said assistance information comprises at least one of
explanatory information;
instructional information;
guiding information;
information concerning at least one source of assistance external to said hearing system.

12. The method according to claim 10, wherein a display of said hearing system is used for carrying out step b).

13. The method according to claim 9, comprising at least one of the steps of
c) customizing said assistance functionality for said individual;
d) using a customized assistance functionality for carrying out step a).

14. A method of manufacturing a hearing system, comprising the step of
m) providing said hearing system with an assistance functionality.

15. The method according to claim 14, wherein said assistance functionality is capable of using a display of a device of said hearing system for providing an individual using said hearing system with assistance information.

16. The method according to claim 14, wherein said assistance functionality is customized for an individual using said hearing system.

17. The method according to claim 14, wherein a hearing system fitting software is used for carrying out step m).

18. A computer program product comprising program code for causing a computer to perform the steps of
p) assisting a person using said computer program product in fitting a hearing system to hearing preferences of an individual using said hearing system;
q) loading definition data into a device of said hearing system, which define an assistance functionality.

19. The computer program product according to claim 18, wherein said program code is adapted to causing said computer to perform the step of
r) assisting a person using said computer program product in customizing said definition data for said individual.

20. The computer program product according to claim 18, wherein said definition data comprises data representing assistance information to be displayed to said individual.
